(19) United States
(12) Patent Application Publication
(10) Pub. No.: US 2002/0060896 A1
(43) Pub. Date: May 23, 2002

(54) Static electricity discharging loader for sheet materials

(75) Inventor: Kang Ting Liu, Kaohsiung (TW)

Correspondence Address: LOWE HAUPTMAN GILMAN & BERNER, LLP, Suite 310, 1700 Diagonal Road, Alexandria, VA, 22314, US

(73) Assignee: HannStar Display Corp.

(21) Appl. No.: 09/946,516

(22) Filed: Sep. 6, 2001

(30) Foreign Application Priority Data
Nov. 17, 2000 (TW) 89220167

(51) Int. Cl. G02F 1/1335

(52) U.S. Cl. 361/221; 361/212

(57) ABSTRACT

A static electricity discharging loader for sheet materials is utilized discharging the static electricity on stacked sheet materials and the sheet materials are stacked on the static electricity discharging loader and the loader comprises a container to contain the sheet materials, a static electricity discharging device with a static electricity discharging brush and when the sheet materials is taken out the container, the sheet materials will contact the static electricity discharging brush and then remove the static electricity on it so that the sheet materials are taken out from the container smoothly.

### FIELD OF THE INVENTION

The present invention generally relates to a static electricity discharging loader for sheet materials, and more particularly, to a static electricity discharging device for LCD polarizers loader.

### BACKGROUND OF THE INVENTION

Due to the advance of electronic technology, especially for the popularity of portable electronic products, the requirements of light, compact and low-energy consuming display are gradually increasing. With the advantages of low-energy consuming, low-heat dissipation, light weight and non-luminescence display, liquid crystal displays (LCD) have been widely used in the electronic products and even have replaced the traditional CRT displays.

A LCD basically consists of polarizers, glass electrodes and liquid crystal materials. The polarizers are made of the polarizer material sandwiched between two transparent films. The glass electrodes are made of high quality flat glass which is plated with a layer of conductive film of metallic oxidation. The molecules of liquid crystal material possess very strong electron conjugation moving ability. When the liquid crystal molecules are applied with electric field, they are easily polarized to produce induced dipolar phenomena, thereby resulting in the displaying image in the LCD.

The manufacturing process of LCD substantially includes the steps of injecting the liquid crystal material into the space between the two flat glasses with glass electrodes thereon, and adhering polarizer films onto the outer surfaces of the flat glasses so as to form the LCD cell. Then the driving circuits, controlling circuits, and backlight components etc. will be assembled to constitute a LCD module.

In LCD manufacturing process, the polarizers are stacked in the polarizer loader and the polarizers are made by cutting the rolled polarizer materials. The adhesive in the polarizers usually overflows during the cutting process so several polarizers adhere together with each other. Furthermore, the polarizers are substantially made of plastic materials, thereby easily resulting in static electricity during the stacking process and further causing the polarizer to adhere with each other. Accordingly, the stacked polarizers cannot be taken out one by one smoothly, thereby resulting in braking the manufacturing process and damage to the polarizers.

Furthermore, the non-conductive sheet materials are extensively used in various industrial products and the sheet materials will adhere to each other due to the static electricity and have the similar problem.

In views of the above problems, there have been the needs to provide a device which is able to discharge static electricity from the stacked sheet materials and/or LCD polarizers such that the stacked sheet materials and/or LCD polarizers can be taken out one by one smoothly.

### SUMMARY OF THE INVENTION

It is a primary object of the present invention to provide a static electricity discharging loader for sheet materials for discharging the static electricity on the stacked sheet materials so that the sheet materials can be taken out one by one smoothly during manufacturing process.

It is a secondary object of the present invention to provide a static electricity discharging loader for sheet materials for discharging the static electricity on the stacked polarizers so that the polarizers can be taken out one by one smoothly during the LCD manufacturing process.

According to the objects of the present invention, a static electricity discharging loader for sheet materials is used for discharging the static electricity in sheet materials which are stacked in the static electricity discharging loader and the loader comprises:

a container for receiving the sheet materials;

a static electricity discharging device with a static brush, wherein when the sheet materials are taken out from the container, the static brush contacts the sheet materials so as to discharge the static electricity on the stacked sheet materials so that the sheet materials can be taken out one by one smoothly from the container.

According to one aspect of the static electricity discharging loader for sheet materials of the present invention, the sheet materials are the polarizers of LCD.

According to one another aspect of the present invention, the static electricity discharging loader for sheet materials comprises a base, and a plurality of slidable side walls for receiving various sizes of stacked polarizer materials.

According to a further aspect of the present invention, the static electricity discharging loader for sheet materials further comprises static electricity discharging air blowing from the static brush for easily separating the stacked sheet materials.

According to the present invention, the static electricity discharging loader for sheet materials can discharge the static electricity from the stacked sheet materials so that the sheet materials can be taken out one by one smoothly from the container.

Other objects, advantages, and novel features of the invention will become more apparent from the following detailed description when taken in conjunction with the accompanying drawings.

### BRIEF DESCRIPTION OF THE DRAWINGS

FIG. 1. is a perspective view of the static electricity discharging loader for sheet materials according to the present invention.

FIG. 2 is a perspective view of the static electricity discharging loader for sheet materials according to the present invention in which the sheet materials have been unloaded.

### DESCRIPTION OF THE PREFERRED EMBODIMENT

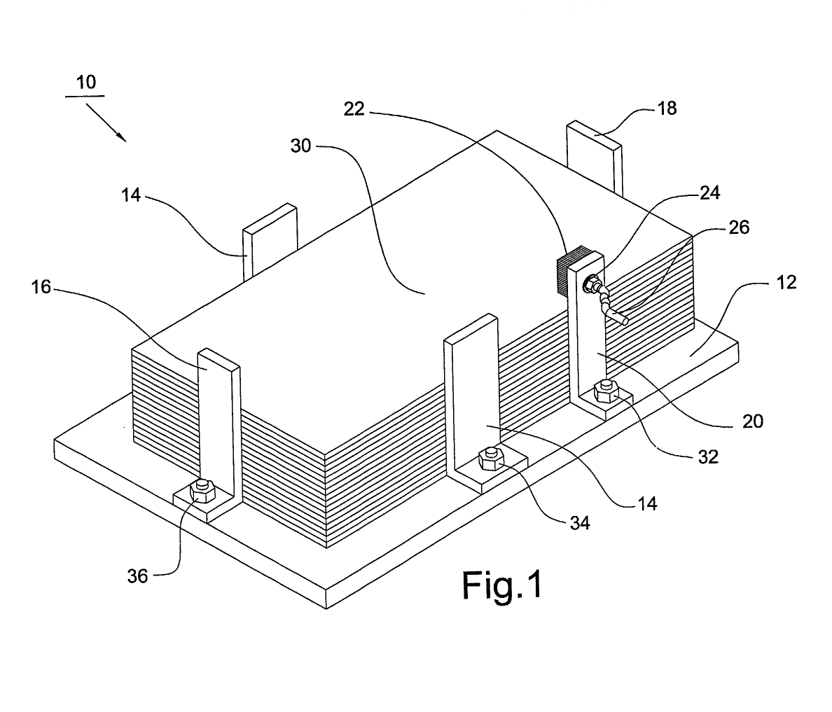

Referring to FIG. 1, it depicts a static electricity discharging loader 10 for sheet materials according to the preferred embodiment of the invention for discharging the static electricity from the sheet materials during the process of manufacturing sheet materials. The sheet materials loader 10 of the present invention can be applied to various processes of manufacturing sheet materials. The following description takes the polarizer of LCD for example to illustrate the static electricity discharging loader for sheet materials 10 according to the preferred embodiment of the invention.

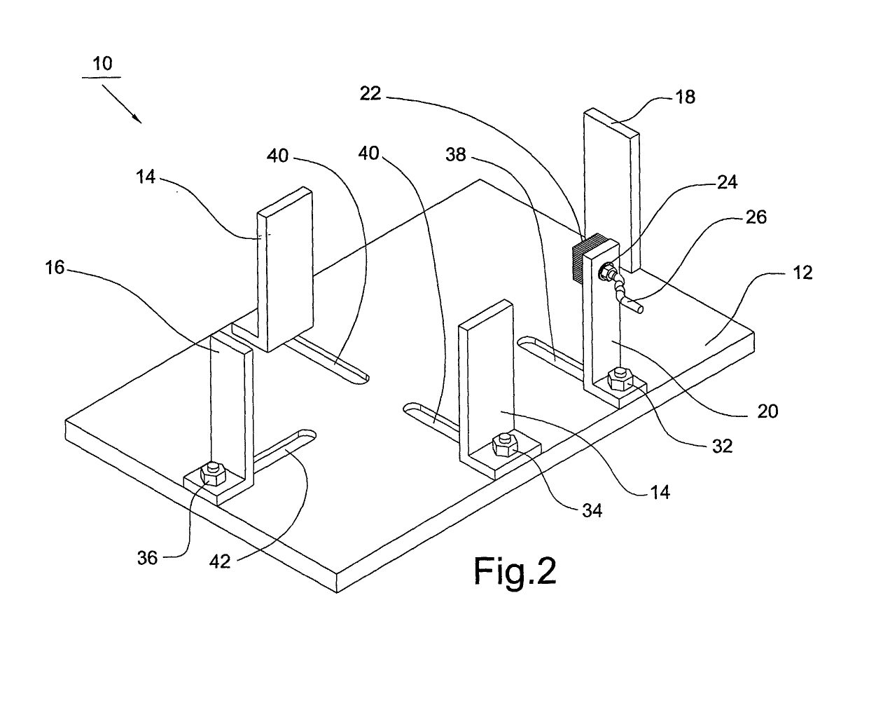

According to the present invention, the loader 10 for sheet materials comprises a base 12, two lateral side walls 14, a longitudinal side wall 16, a fixed side-wall 18 and a static electricity discharging device 20. The base 12 has a substantially flat configuration to load sheet materials 30 such as a polarizer. The two lateral side walls 14 and the longitudinal side wall 16 can slide relative to the base 12 along slots 40 and 42 by adjusting the fixed bolts 34 and 36 (as shown in FIG. 2). Various sizes of polarizers can be received in the loader 10 with the cooperation of the two lateral side walls 14 and the longitudinal side wall 16 and the fixed side wall 18.

The static electricity discharging device 20 can be slidably fixed to the base 12 by the sliding members such as the slot 38 and the bolt 32 (shown in FIG. 2 ). By this method, the position of static electricity discharging device 20 can be adjusted according to the sizes of the polarizer 30 for contacting the polarizer 30 appropriately. The static electricity discharging device has a brush 22 for discharging the static electricity from the polarizer 30 when the brush 22 contacts the polarizer 30, whereby the sheet materials can be taken out one by one smoothly from the loader 10.

In the static electricity discharging device 20, the plug 24 of the brush 22 is further connected to a static electricity discharging air source (not shown in the figures). By this arrangement, the static electricity discharging air is transferred to the brush 22 to further discharge the static electricity from the stacked polarizers 30. Furthermore, it should be appreciated by the people skilled in the art that the adhering forces between the polarizers comprise the static electricity, the adhesive force of the overflown adhesive and the force resulted from the vacuum among the flat polarizers. Therefore, the supply of the static electricity discharging air not only can discharge the static electricity from the polarizers 30, but also can reduce the vacuum among the polarizers 30 and supply a drag force for separating the adhered polarizers so that the polarizers 30 can be taken out one by one smoothly.

Although the invention has been explained in relation to its preferred embodiment, it is not used to limit the invention. It is to be understood that many other possible modifications and variations can be made by any people skilled in the art without departing from the spirit and scope of the invention as hereinafter claimed.

What is claimed is:

1. A static electricity discharging loader for sheet materials is used for discharging the static electricity in stacked sheet materials and the sheet materials are stacked in the static electricity discharging loader and the loader comprises:
a container for receiving the sheet materials;
a static electricity discharging device with a static electricity discharging brush and when the sheet materials are taken out from the container, the sheet materials will contact the static electricity discharging brush and the static electricity on it will be discharged so that the sheet materials are taken out from the container smoothly.

2. A static electricity discharging loader for sheet materials of claim 1, wherein the sheet materials are the polarizers of LCD.

3. A static electricity discharging loader for sheet materials of claim 1, wherein the container comprises a base and multiple of slidable side walls for stacked various sizes of polarizers.

4. A static electricity discharging loader for sheet materials of claim 3, wherein the static electricity device is placed at least one of the multiple slidable side walls.

5. A static electricity discharging loader for sheet materials of claim 1, wherein the static electricity discharging air blows from the static electricity brush and results in the stacked sheet materials separated easily.

6. A static electricity discharging loader for sheet materials of claim 1, wherein the static electricity device has slidable fixed members so that the static electricity discharging brush easily contacts various sizes of sheet materials and discharging the static electricity adhering thereto.
